(19) United States
(12) Patent Application Publication
(10) Pub. No.: US 2006/0108076 A1
(43) Pub. Date: May 25, 2006

(54) Rotor brake mechanism for curtain linkage system

(76) Inventor: Shien-Te Huang, Taipei (TW)

Correspondence Address: Shien-Te Huang, P.O. Box No. 6-57, Junghe, Taipei, 235, TW

(21) Appl. No.: 10/991,530

(22) Filed: Nov. 19, 2004

(51) Int. Cl. E06B 9/307

(52) U.S. Cl. 160/176.1 R

(57) ABSTRACT

A rotor brake mechanism for curtain linkage system, wherein a reverse acting force brake mechanism is indirectly produced between a drive unit and a roll-up and release mechanism. The rotor brake mechanism primarily utilizes a turntable, whereon three blocking rods are separately disposed and three slide grooves are separately defined so as to be equi-angularly spaced on the turntable thereof. The slide grooves provide for movably disposing of rollers therein. A triangular rotor is movable disposed within the rotor brake mechanism. The turntable and a combinatory member are clamped as a pair on front and rear end openings of a limit ring respectively. Utilizing the correspondingly configured slide grooves, two points from such can thus determine a straight line relation, and utilizing the three blocking rods, three points can determine a plane, thereby uniformly distributing acting forces and effectuating unhindered operation therefrom.

### BACKGROUND OF THE INVENTION

(a) Field of the Invention

The present invention relates to a rotor brake mechanism for curtain linkage system, more particularly to a curtain linkage system, wherein a reverse acting force brake mechanism is indirectly produced between a drive unit and a roll-up and release mechanism.

(b) Description of the Prior Art

Regarding a brake mechanism of a curtain linkage system, reasons for necessity of such a brake configuration are that during course of releasing curtain slats or at a time of implementing opening of the curtain slats, the slats can be subject to external force effects of airflow, wind pressure, and so on, whereupon reverse transmission to a drive unit results, which causes deformation in anti-dazzling surfaces of the slats or deviation in angle of anti-dazzle (see FIG. 1).

The curtain set 5 primarily comprises a top rail 51 with slats 53 configured below, and the top rail 51 is connected to a bottom rail 54 through a ladder cord 55.

The ladder cord 55 winds round a reel 52, moreover, the reel 52 and an angular transmission shaft 50 are assembled as a roll-up and release mechanism 520, whereby the angular transmission shaft 50 is actuated by a drive unit 2, and thereby produces a motive force upon the slats 53.

Upon the slats 53 being subject to external forces, the forces acting upon the slats are transmitted to the reel 52 through the ladder cord 55, whereupon the reel 52 indirectly transmits the forces back to the drive unit 2 through the angular transmission shaft 50.

In order to prevent variation in anti-dazzle state of the slats 53, and ensure safety of the drive unit 2, a brake mechanism 1 is inter-disposed between the drive unit 2 and the angular transmission shaft 50. The brake mechanism 1 effectuates a brake effect by means of a reverse acting force of reverse transmission of the angular transmission shaft 50.

In reverse, the brake mechanism 1 can outwardly transmit and thereby transfer motive power inputted by the drive unit 2 to the angular transmission shaft 50.

Regarding a brake mechanism 1, previous patents include U.S. Pat. No. 4,372,432, which utilizes variation in internal diameter of a spring, and thereby locking interrelated shafts (see FIG. 2), and embraces a primary component configuration embodying a core 34 fixedly configured to a bracket 15, and interrelated to the core 34 are a driving member 66 and a spring 48 and a sleeve portion 106 union jointed along an axle center line of the core 34 thereof. The sleeve portion 106 outwardly releases motive power through a driven member 98, and a driving member 66 is movably disposed on a peripheral surface of the core 34. A rib element 132 is configured so as to backwardly extend from the driving member 66. The spring 48 is sleeve disposed on the peripheral surface of the core 34. A U-shaped channel 138 is defined in the sleeve portion 106, and two sides of the U-shaped channel 138 form tang-abutting surfaces 140 and 143. Protruding tangs 116 and 118 separately radially extend from front and rear ends of the spring 48 respectively, and the tangs 116 and 118 are movably disposed on the corresponding tang-abutting surfaces 140 and 143 of the U-shaped channel 138. The rib element 132 configured on the driving member 66 is positioned between the tangs 116 and 118 of the spring 48. When the driving member 66 is subject to pulling motion by a shade cord 76, the rib element 132 first presses alongside the tangs 116 or 118, whereupon the tangs 116 and 118 of the spring 48 further tangentially press the tang-abutting surfaces 140 and 143 of the U-shaped channel 138, which thereby outwardly transfer turning motive power towards the driven member 98 from the turning motive power acquired by the shade cord 76. In reverse, when the driven member 98 transmits back a recoil force, then through effect of the two tang-abutting surfaces 140 and 143 configured on the U-shaped channel 138 first pressing on the tangs 116 and 118 of the spring 48 by way of a sleeve portion 106, the tangs 116 and 118 are subject to radial torsion from the sleeve portion 106, and will thereby cause internal diameter of the spring 48 to reduce in size according to elastic variability of the spring 48. Furthermore, because the spring 48 is movably disposed on a surface of the core 34, and moreover, the core 34 is fixedly configured to the bracket 15, thus upon the internal diameter of the spring 48 being reduced in size, then the spring 48 will tighten on the circumferential surface of the core 34, thereby forming a reverse brake effect. However, utilizing a brake method effectuated by means of tightening of the spring 48 on the core 34, when the internal diameter of the spring 48 is changed, if a reverse acting force of the driven member 98 is greater than friction force between the spring 48 and the core 34, slippage results. Furthermore, actuating the spring 48 each time by operating the shade cord 76 produces an elastic acting force therefrom, which easily results in elastic fatigue of the spring 48.

### SUMMARY OF THE INVENTION

The present invention particularly utilizes a turntable, and a turntable coaxial with a limit ring, and which is union jointed to a combinatory member. Three blocking rods are separately disposed so as to be equi-angularly spaced on the turntable, and three slide grooves are further defined in the turntable, and which allow movement in direction of center of the turntable thereof. Front and rear ends of three rollers are separately movably disposed in the aforementioned slide grooves of the turntable and slide grooves of the combinatory member respectively, and thereby inter-disposed between the turntable and the combinatory member. A triangular shaped rotor is configured so as to be movably disposed interior of the three rollers and the three blocking rods, and which actuate corresponding movement of the rotor thereof.

Because the front and rear ends of three rollers are movably disposed in the aforementioned slide grooves, thus two points from such can thus determine a straight line relation, and be utilized to receive uniform acting forces which effectuate smooth sliding, thereby allowing shortening in length of the rollers, which correspondingly reduces thickness of entire brake mechanism.

Utilizing the three rollers and the three blocking rods, optimum average component load on a circular plane is attained, thereby acquiring unhindered and unequivocal operating and braking action.

After assemblage, the brake mechanism forms a functional entity configured as a single body, which thereby facilitates post-production assembly.

A corresponding motive power input terminal can be directly coupled to the drive unit, and a motive power output terminal directly connects to an outward transmission shaft by means of a shaped orifice defined center of the rotor which provides for direct inserting of the outward transmission shaft therein. Compared to relatively loose configurations of conventional designs, the present invention benefits post-assembly of curtain linkage system.

Regarding manufacturing methods of each component, apart from the shafts, all other components can each be formed from a single punch by adopting a punching method, and assembled by employing tolerance crimping assembly. Manufacture working procedure is extremely simple, convenient and fast.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an assembled schematic view of a conventional curtain set.

FIG. 2 shows an exploded elevational schematic view of relative relationship of essential elements of a conventional brake mechanism.

FIG. 3 shows an assembled side schematic view of an embodiment according to the present invention.

FIG. 4 shows an assembled schematic view of a brake mechanism being employed in a curtain set according to the present invention.

FIG. 5 shows an exploded elevational schematic view of the brake mechanism and related assemblage according to the present invention.

FIG. 6 shows an elevational schematic view of the brake mechanism assembled and functioning as a single body according to the present invention.

FIG. 7 shows a cross-sectional motion view depicting a turntable actuating a rotor according to the present invention.

FIG. 8 shows a cross-sectional motion view depicting reverse direction acting force of the rotor effectuating a brake effect according to the present invention.

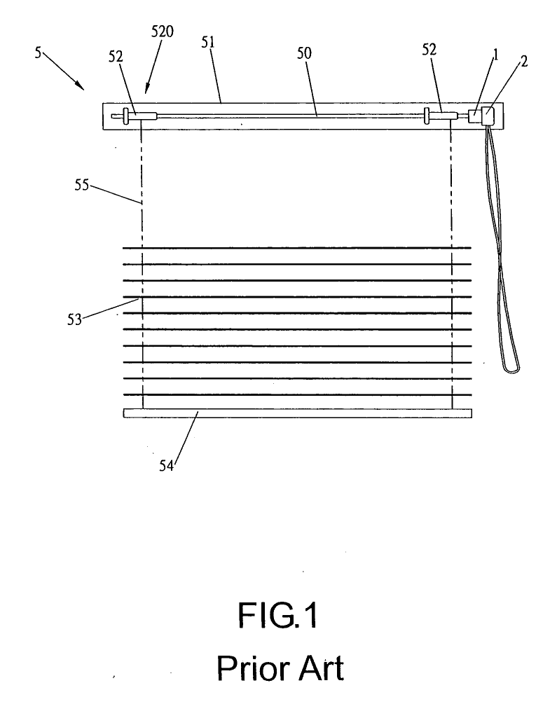

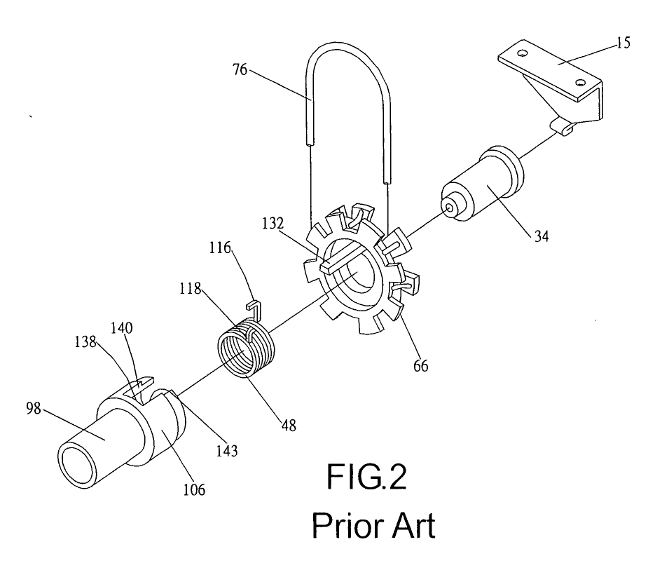

### DETAILED DESCRIPTION OF THE PREFERRED EMBODIMENTS

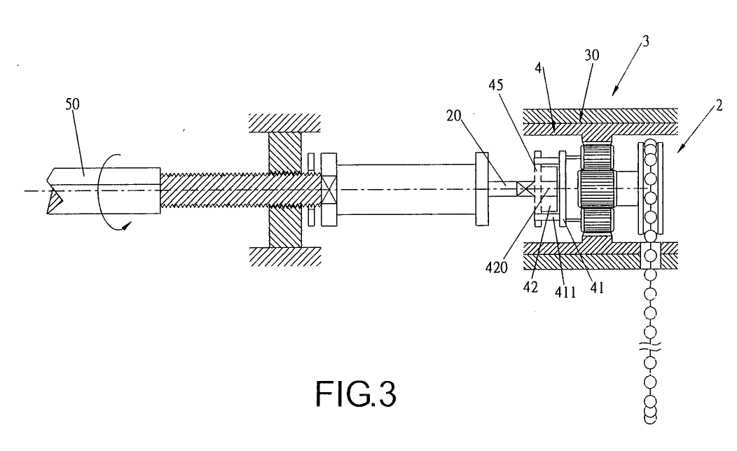

Referring to FIG. 3, which shows a detailed configuration according to the present invention, and which primarily comprises a drive unit 2. A converter device 3 can be inter-disposed between the drive unit 2 and a brake mechanism 4 according to needs of velocity torsion, and which transmits appropriate motive power to the brake mechanism 4 therewith.

The motive power of the drive unit 2 is directly transmitted to a turntable 41 of the brake mechanism 4, which realizes direct actuation of the turntable 41 thereof. Blocking rods 411 are disposed on the turntable 41, and configured so as to inwardly face therefrom, wherewith checking motion of a rotor 42 is effectuated. The drive unit 2 and the brake mechanism 4 are embodied in a housing 30 thereby forming a single body.

A shaped orifice 420 is defined in the rotor 42, and which provides for a linkage system shaft 20 to connect thereinto. Accordingly, the motive power of the drive unit 2 is transmitted to an angular transmission rod 50 through the linkage system shaft 20.

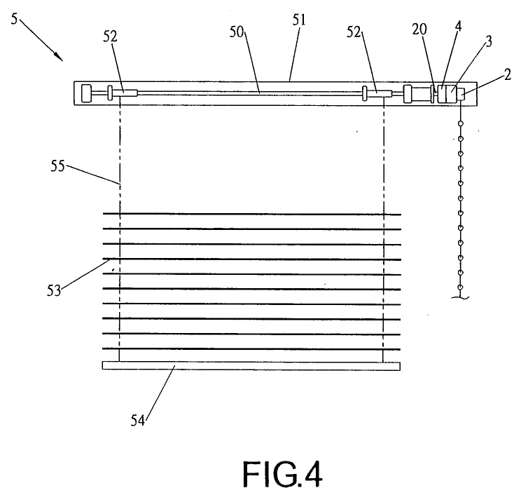

FIG. 4 shows an implementation of the present invention in a curtain set configuration, wherein the drive unit 2 is configured at one end of a top rail 51 of the curtain set 5, and which coaxially drives the converter device 3. Furthermore, the converter device 3 actuates a brake mechanism 4 through a coaxially linkage system.

The brake mechanism 4 actuates a transmission shaft 50 through the linkage system shaft 20, whereupon the transmission shaft 50 further actuates a reel 52. Roll-up and release operation of slats 53 is effectuated by means of a ladder cord 55, which thereupon actuates opening and releasing of the slats 53 and the bottom rail 54.

When the slats 53 are subject to external forces, then a recoil force is transmitted to the transmission shaft 50 through the reel 52, whereupon the transmission shaft 50 further reverse transmits back the recoil force by way of the linkage system shaft 20.

The recoil force thus first traverses braking of the brake mechanism 4, and effectuates retaining immobility of the transmission shaft 50 based on braking effectiveness of the brake mechanism 4, thereby ensuring when the slats 53 or the bottom rail 54 are subject to the external forces the slats 53 are kept open and no deformation results.

In order to provide for accommodating requirements for manual operation or motor driven operation of the drive unit 2, the converter device 3 is inter-disposed between the drive unit 2 and the brake mechanism 4 or the converter device 3 is dispensed with, which allows for the drive unit 2 to directly actuate the brake mechanism 4, as depicted in FIG. 3.

When the drive unit 2 indirectly transmits the motive power to the brake mechanism 4 by way of the velocity torsion converter device 3, the converter device 3 is configured as a planetary gear set, which thus effectuates enlarging torsion transmission and transmits the motive power of the drive unit 2 to the brake mechanism 4.

If rotational velocity of the turntable 41 is increased, then the drive unit 2 can directly actuate the brake mechanism 4, thus dispensing with need for the converter device 3. Whereas, existence of the converter device 3 particularly benefits application in electric motor driven mode.

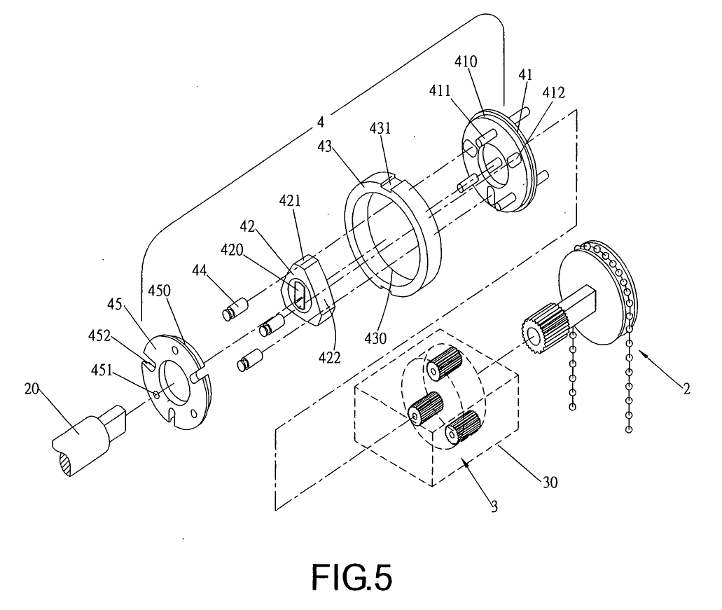

Regarding structural configuration of the brake mechanism 4 of the present invention, and referring to FIG. 5, which shows a configuration primarily comprising the turntable 41 actuated on one side by the drive unit 2 through the converter device 3, the drive unit 2 and the brake mechanism 4 are disposed along an axle center line, while the entire configuration is embodied in a housing 30 so as to form a single body.

Three blocking rods 411 are separately configured so as to be equi-angularly spaced on an outwardly facing output direction of the turntable 41, and slide grooves 412 are further defined in the turntable 41 so as to be symmetrically spaced between each of the blocking rods 411.

Corresponding to and opposite to the turntable 41 is configured a combinatory member 45, and slide grooves 452 corresponding to the slide grooves 412 in the turntable 41 are defined in the combinatory member 45. Butt joint holes 451 are further defined so as to correspond to the blocking rods 411. The turntable 41 and the combinatory member 45 are clamped as a pair on front and rear end openings of an inner circumference 430 of a limit ring 43 respectively. Fixing portions 431 are configured on the limit ring 43 so as to expedite fixing to the housing 30 thereof.

Hence, in order to realize restriction along a coaxial line, and for the turntable 41 and the combinatory member 45 to be configured face to face on end openings of the inner circumference 430 of the limit ring 43, indented locating rebates 410 and 450 are configured on an outer periphery of the limit ring 43 and the combinatory member 45 respectively, The locating rebates 410 and 450 thereby enable the turntable 41 and the combinatory member 45 to be coaxially configured face to face on the limit ring 43.

The shaped orifice 420 defined center of the triangular shaped rotor 42 provides for the linkage system shaft 20 to be assembled thereinto.

Three rollers 44 are movably disposed in the aforementioned slide grooves 412 by means of a movable disposal configuration, and which effectuate inward-outward sliding in direction of center of the turntable 41 according to configured direction of the slide groove 412 (452).

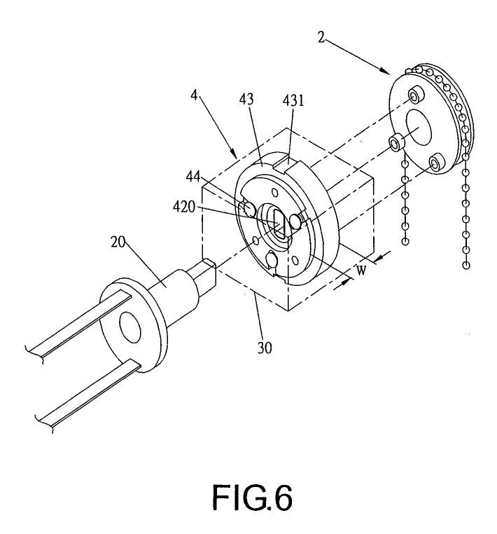

Retaining tangent planes 421 and tangent pressure planes 422 are configured on the rotor 42 relative to relationship of the rollers 44 and the blocking rods 411. Referring to FIG. 6, after assemblage of the entire configuration, the brake mechanism 4 forms a single body.

The limit ring 43 is outwardly fixed and deemed to be in a fixed state by means of the fixing portions 431. The drive unit 2 transmits the driving motive power to the brake mechanism 4, and the brake mechanism 4 utilizes the blocking rods 411 to actuate the rotor 42, whereupon the shaped orifice 420 configured center of the rotor 42 actuates the linkage system shaft 20.

The brake mechanism 4 is basically an assemblage functioning as a single body, which thereby facilitates post-production assembly.

Regarding thickness W of the brake mechanism 4, because front and rear ends of the aforementioned rollers 44 are configured to be movably fixed, thus two points can be formed to determine a straight line relation, which thereby enables reduction in length of the rollers 44, while correspondingly enabling reduction in the thickness W of the brake mechanism 4. Assemblage space requirements are thus contracted, which thereby benefits accommodating present meticulous demands for light and small fittings.

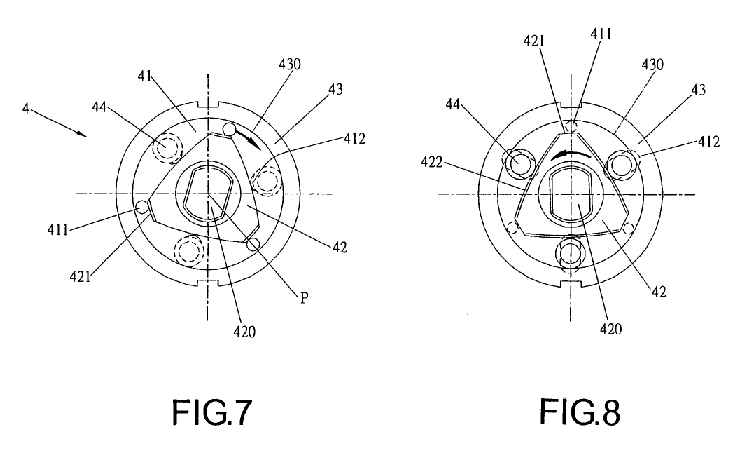

Regarding working principle of the brake mechanism 4 of the present invention, refer to FIG. 7, which depicts the rotor 42 being actuated by the driven turntable 41.

The rotor 42 rotates in a clockwise direction and actuates the blocking rods 411, which tangentially press on the retaining tangent planes 421 of the rotor 42, and thereupon push and rotate the rotor 42 in an anticlockwise direction. Surfaces of the retaining tangent planes 421 are of arc-shaped form, and radius of each of the arc-shapes is greater than radius distance between inner circumferential tangent point of the blocking rods 411 and center point P.

Hence, when the turntable 41 actuates the blocking rods 411 into motion, and upon the blocking rods 411 reaching a side of each of the retaining tangent planes 421, because two sides of the retaining tangent planes 421 protrude relatively outwards, the blocking rods 411 are blocked thereat, whereupon the shaped orifice 420 is actuated to transmit the corresponding output motive power.

Referring to FIG. 8, which shows the rotor 42 being subject to an external force reverse transmission motive power, whereupon the rotor 42 first actuates the rollers 44 through the tangent pressure planes 422.

The rollers 44 outwardly displace according to specifications of the slide grooves 412, and upon reaching the inner circumference 430 of the limit ring 43 are subject to influence of the inner circumference 430 and a brake effect is formed thereat, which disables the rotor 42 from rotating, thereby achieving effectiveness of braking.

The aforementioned FIGS. 7 and 8 show relative movement of the blocking rods 411 and the rollers 44, wherein upon the turntable 41 (see FIG. 7) outputting motive power, the blocking rods 411 alone block movement of side end locations of the retaining tangent planes 421 configured on the rotor 42, thereby achieving transferal of the motive power to the rotor 42 and actuation thereof. Furthermore, because the rollers 44 are confined to the slide grooves 412, and thus are subject to simultaneous movement by the slide grooves 412. Hence, the rollers 44 and the inner circumference 430 of the limit ring 43 are kept at a definite distance and will not become jammed.

Referring to FIG. 8, when the rotor 42 is rotating, the rollers 44 are first actuated, and thus move outward guided by the slide grooves 412, whereupon spaced tangential pressure on the inner circumference 430 of the limit ring 43 is effectuated and a locking effect is formed thereat.

Prior to blocking and the locking effect, there is no contact between the retaining tangent planes 421 of the rotor 42 and the blocking rods 411, thus the locking effect of the rollers 44 is achieved beforehand.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A rotor brake mechanism for curtain linkage system comprising a reverse brake mechanism configured between a drive unit and a roll-up and release mechanism, one end of the brake mechanism is subject to transmission from the drive unit, and an output terminal is connected to a transmission shaft; and characterized in that:
the brake mechanism comprises a turntable coaxial with a limit ring, and which is union jointed to a combinatory member;
three blocking rods are separately disposed so as to be equi-angularly spaced on the turntable, and configured so as to face inward of the limit ring, and three slide grooves are further defined in the turntable, and which allow movement in direction of center of the turntable thereof;
corresponding to and opposite to the turntable is configured the combinatory member, and slide grooves corresponding to the slide grooves in the turntable are defined in the combinatory member, and butt joint holes are further defined so as to correspond to the blocking rods;
front and rear ends of three rollers are separately movably disposed in the aforementioned slide grooves of the turntable and slide grooves of the combinatory member respectively;
a triangular shaped rotor is configured so as to be movably disposed within the three rollers and the three blocking rods, and which actuate corresponding movement of the rotor thereof;
a shaped orifice is defined center of the rotor, and three tangent pressure planes and three retaining tangent planes are separately qui-angular configured on periphery of the rotor, the tangent pressure planes actuate the aforementioned rollers, and the retaining tangent planes provide for blocking of the aforementioned blocking rods.

2. The rotor brake mechanism for curtain linkage system according to claim 1, wherein locating rebates are configured on the turntable and the combinatory member so as to enable disposing the turntable and the combinatory member face to face on front and rear end openings of an inner circumference of the limit ring respectively.

3. The rotor brake mechanism for curtain linkage system according to claim 1, wherein the drive unit can be motor driven or manual operated.

4. The rotor brake mechanism for curtain linkage system according to claim 1, wherein a torsion converter mechanism can be configured between the drive unit and the brake mechanism thereof.

5. The rotor brake mechanism for curtain linkage system according to claim 3, wherein a torsion converter mechanism can be configured between the drive unit and the brake mechanism thereof.
